(19) United States
(12) Patent Application Publication
(10) Pub. No.: US 2013/0240763 A1
(43) Pub. Date: Sep. 19, 2013

(54) APPARATUS AND METHODS FOR REDUCING SOILING OF RADIO-OPAQUE SHIELDS

(71) Applicants: Ashok C. Khandkar, Salt Lake City, UT (US); Prataprai Chowdhary, Round Rock, TX (US); Christin Choma, Draper, UT (US)

(72) Inventors: Ashok C. Khandkar, Salt Lake City, UT (US); Prataprai Chowdhary, Round Rock, TX (US); Christin Choma, Draper, UT (US)

(73) Assignee: BloXr Corporation, Salt Lake City, UT (US)

(21) Appl. No.: 13/421,961

(22) Filed: Mar. 16, 2012

(51) Int. Cl. G21F 3/00; B32B 3/06; B23P 19/00; B32B 5/02

(52) U.S. Cl. 250/515.1; 428/221; 442/93; 428/343; 428/99; 428/537.5; 29/426.1

(57) ABSTRACT

Shields that attenuate ionizing radiation (e.g., x-rays, gamma rays, etc.) include outer layers that minimize soiling. Removable shells that minimize soiling of shields for attenuating ionizing radiation are also disclosed. The soil-minimizing outer layers and shells may be formed from materials that resist soiling, that counteract soiling, or from which soiling may be readily removed. Methods for minimizing soiling of radio-opaque shields are also disclosed.

### TECHNICAL FIELD

This disclosure relates generally to shields that attenuate ionizing radiation. More specifically, this disclosure relates to apparatus for maintaining the shields and garments that attenuate ionizing radiation in a clean and/or hygienic state,

### RELATED ART

A variety of shields and garments have been developed to limit exposure of individuals to ionizing radiation (e.g., x-rays, gamma rays, etc.). Examples of such shields and garments include aprons, thyroid shields and gloves. Conventionally, ionizing radiation-attenuating shields and garments are lead (Pb)-based, as lead has tong been the material of choice for attenuating ionizing radiation, Other materials that attenuate ionizing radiation, which are also referred to as “radio-opaque” materials, including lead-based materials and lead-free materials, have also been used in ionizing radiation-attenuating shields and garments, The radio-opaque material of a shield or garment is typically encased in a manner that ensures that the shield or garment will uniformly limit attenuate a desired amount, or intensity, of ionizing radiation. In many implementations, the encased radio-opaque material is then covered with an outer layer, which may impart the shield or garment with a pleasant look or feel, and may be configured with one or more features that enable the shield or garment to be secured to an individual's body.

For a variety of reasons, including the expense of radio-opaque materials, shields and garments that attenuate ionizing radiation are typically configured to be used repeatedly, often over long periods of time (typically years). With repeated use, the outer layers of shields or garments may be soiled or contaminated (e.g., with microorganisms, etc.), they may absorb odors or their presentation may otherwise be diminished. For the sake of simplicity, any action that might diminish the presentation of a shield or garment is referred to herein as “soiling” or some variant of that term. Soiling may be caused by a variety of factors, including, without limitation, as an individual's perspiration comes into contact with the shield or garment, as the garment is exposed to foreign substances (makeup, perfume, deodorant, microorganisms, body fluids, etc.) on an individual's body and as foreign substances from the environment in which the shield or garment is used come into contact with the shield or garment.

In some environments (e.g., hospitals, doctor's offices, dental offices, etc.), people have high expectations of cleanliness and even sterility. A shield or garment may be used on a large number of different people (e.g., patients, etc.) in such an environment, or individuals (e.g., patients, etc.) may see a worker (e.g., a healthcare provider, etc.) in such an environment wearing a shield or garment configured for repeated use. The presence and use of a soiled ionizing radiation-attenuating shield or garment in such an environment may be viewed unfavorably by visitors to (e.g., patients receiving care in, etc.) that environment. Furthermore, any contaminants on a shield or garment may be undesirably transferred to other individuals (e.g., patients, healthcare workers, etc.) who are present in the same setting.

### SUMMARY

In various aspects, this disclosure relates to apparatuses and techniques for minimizing soiling of or removing soiling from ionizing radiation-attenuating shields and garments that are configured for repeated use. Such shields and garments, which are collectively and more simply referred to hereinafter as “shields,” may be configured to attenuate one or more types of ionizing radiation (e.g., x-rays, gamma rays, etc.).

In one aspect, this disclosure relates to shields with outer layers that are configured to minimize soiling, such as by resistance to soiling, by facilitating the ready removal of soiling and/or by eliminating one or more types of soiling. Structures, such as the outer layer of a shield, that are configured to minimize soiling are referred to herein as “soil-minimizing” structures. In embodiments where a soil-minimizing outer layer is configured to resist soiling, the material of the outer layer may resist soiling, the material of the outer layer may be coated with a material that resists soiling or the outer layer may be formed from a soil-resistant material and include a soil-resistant coating. in embodiments where a soil-minimizing outer layer is configured to reduce or eliminate soiling, the material from which the outer layer is formed may comprise or carry a material or a combination of materials that remove or otherwise eliminate certain types of soiling (e.g., odors, microorganisms, etc.). Alternatively, or in addition, a soil-minimizing outer layer may comprise a “cleanable outer layer,” which may be formed from a material from which contaminants, odors and other types of soiling are readily removed (e.g., by wiping, with disinfectants and/or deodorants, by washing or other types of cleaning, etc.). In some embodiments, a shield that includes a soil-minimizing outer layer may be configured to withstand sterilization while maintaining its ability to minimize soiling.

In another aspect, this disclosure relates to removable shells for shields. A removable shell may be configured to be positioned over and secured to any type of shield, including a conventional shield or a shield with a soil-minimizing outer layer. A removable shell may be configured to be positioned and retained over a shield white the shield is in use, and to be removed from the shield when the shield is not in use. In some embodiments, a removable shell may simply provide a barrier that prevents soiling of the shield. In other embodiments, the removable shell may comprise a soil-minimizing material.

A removable shell may be configured for re-use (e.g., it may be configured for cleaning, washing, etc.) or it may be configured to be disposed of once its soiling becomes apparent. In some embodiments, particularly where a shield will be used in a sanitary or sterile environment, a shell may be configured to be sterilized.

Other aspects of the inventive subject matter of this disclosure, as well as features and advantages of various aspects of that subject matter, will become apparent to those of ordinary skill in the art through consideration of the ensuing description, the accompanying drawings, and the appended claims.

### BRIEF DESCRIPTION OF THE DRAWINGS

In the drawings:

FIG. 1 illustrates an embodiment of a shield for attenuating ionizing radiation, which shield includes a soil-minimizing outer layer;

FIG. 2 is a cross-section of the shield shown in FIG. 1;

FIG. 3 depicts an embodiment of a shell for use with a shield that attenuates ionizing radiation;

FIG. 4 shows an embodiment of the manner in which the shell of FIG. 3 may be secured to a shield that the shell is configured to complement;

FIG. 5 is a cross-sectional representation of the assembly shown in FIG. 4;

FIG. 6 illustrates another embodiment of a shell for use with a shield that attenuates ionizing radiation;

FIG. 7 shows an embodiment of the manner in which the shell of FIG. 6 may be secured to a shield that the shell is configured to complement; and

FIG. 8 is a cross-sectional representation of the assembly depicted by FIG. 7.

### DETAILED DESCRIPTION

Various embodiments of apparatuses and techniques for minimizing soiling of shields that attenuate ionizing radiation are described herein. Among other embodiments, a shield may be configured in a way that minimizes its own soiling or a shell may be configured to prevent soiling of a shield. Methods in which soiling of shields is minimized are also described.

In FIGS. 1 and 2, an embodiment of a shield 10 that minimizes ionizing radiation is illustrated. That shield 10 includes a radio-opaque material 12, an encapsulant 13 and an outer layer 19. The radio-opaque material 12 is distributed across much of the area defined by the shield 10. The encapsulant 13 may contain the radio-opaque material 10 and ensure that the radio-opaque material 12 remains distributed across its intended area. The outer layer 19 covers the encapsulant 13, and may impart the shield 10 with a desired look or feel.

Without limiting the scope of the disclosed subject matter, the radio-opaque material 12 may comprise any material that is known to attenuate ionizing radiation to a degree that is suitable for use in a garment or shield intended to limit an individual's exposure to ionizing radiation. In conventional shields 10, the radio-opaque material 12 often comprises lead or a lead-based material. In some embodiments, in addition to lead and/or a lead-based material, the radio-opaque material 12 may include other metals, such as tin, tungsten, antimony, barium, etc.

A radio-opaque material 12, such as lead or a lead-based material, is typically blended with an encapsulant 13. In various embodiments, the radio-opaque material 12 is in a particular form, such as a powder, small particles or larger pellets. The encapsulant 13 may comprise a flexible material; for example, an elastomer such as a synthetic rubber, polyvinyl chloride (PVC) or the like. In some embodiments, the radio-opaque material 12 and the encapsulant 13 are homogeneously mixed and formed into sheets 14. In some embodiments, the encapsulant 13 may comprise or be blended with a material that minimizes soiling. Non-limiting examples of such materials include soil-reducing agents (as described in further detail hereinafter), deodorants, antimicrobial agents and the like.

As an alternative to conventional radio-opaque materials, the radio-opaque material 12 of a shield 10 of the present invention may comprise a non-toxic material and/or a material based on an element having an atomic number of 56 or greater. Non-limiting examples of such elemental species include barium species, bismuth species and lanthanum species. In some embodiments, the radio-opaque material 12 may comprise an inorganic salt. Non-limiting examples of non-toxic, radio-opaque inorganic salts include barium sulfate and bismuth oxide. Such materials are disclosed in U.S. patent application Ser. No. 12/897,611, titled “RADIO-OPAQUE FILMS OF LAMINATE CONSTRUCTION” and filed on Oct. 4, 2010 (hereinafter “the '611 Application”), the entire disclosure of which is, by this reference, hereby incorporated herein.

When radio-opaque materials 12 such as those disclosed by the '611 Application are used in a shield 10, they may comprise particles (e.g., fine particles of a powder, larger particles, pellets, etc.) that be homogenously mixed with and held together by a binder, or encapsulant 13.

In some embodiments, the types of radio-opaque materials 12 disclosed by the '611 Application may be encapsulated with a flexible material, Examples of suitable encapsulants 13 include, but are not limited to, elastomers such as a synthetic rubber, polyvinyl chloride (PVC) or the like. In some embodiments, the radio-opaque material 12 and the encapsulant 13 are homogeneously mixed and formed into sheets 14.

Alternatively, particles of radio-opaque materials 12 of the types disclosed by the '611 Application may bound together with a material that will hold particles of the radio-opaque material 12 together without causing a substantial decrease in the density of the radio-opaque material. Such a binder material is also referred to herein as an encapsulant 10. The encapsulant 13 may hold particles of radio-opaque material together loosely, it may provide a stronger bond between adjacent particles, and/or it may enable the formation of a smooth uniform coating, or film. Examples of materials that may be suitable for use as the encapsulant 13 include, but are not limited to, elastomers, such as polyvinyl alcohol (PVA), polyvinyl butyrol (PVB), polyethylene glycol (PEG), glycerine, capric triglyceride, cetyl alcohol, glyceryl sterate and combinations of any of these materials. In addition, in some embodiments, the encapsulant 13 comprise or be blended with a material that minimizes soiling, such as a soil-reducing agent (as disclosed in further detail hereinafter), a deodorant, an antimicrobial agent or the like. As disclosed by the '611 Application, the radio-opaque material 12 and a binder-type encapsulant 13 may be disposed between a pair of containment layers 17, such as polymer films, foils, or the like, to form sheets 14.

Two or more (e.g., up to five, etc.) of the sheets 14 may be used to form a laminate structure 15. A cover 16 may be provided over (e.g., secured to, etc.) the laminate structure 15. The cover 16, which may comprise a flexible material, may provide a seal for the laminate structure 15. In some embodiments, the cover 16 may comprise a fabric formed from synthetic fibers (e.g., nylon, etc.) and/or from a material that minimizes soiling, embodiments of which are described in detail hereinafter in reference to the outer layer 19. A polymer film 17 may coat a surface of the cover 16 disposed against the laminate structure 15. In some embodiments, the cover 16 may comprise an outer layer 19 of the shield 10.

The outer layer 19 of a shield 1 that incorporates teachings of this disclosure may comprise a material that resists soiling, a material that reduces or eliminates soiling, or a material from which soiling is readily removed.

In embodiments where a shield 10 is configured to resist soiling, its outer layer 19 formed from a material that resists soiling, the material of its outer layer 19 may be coated or otherwise treated with a material that resists soiling, or the outer layer 19 may include a soiling-resistant material treated with soiling-resistant material, In some embodiments, the outer layer 19 of the shield 10 may include a plurality of different soiling-resistant materials, which may resist the same types of soiling, similar types of soiling or different types of soiling.

Various embodiments of materials that resist soiling include, but are not limited to, use of materials that are generally water-repellant, or hydrophobic. Hydrophobic materials that may be used to form fibers and, thus, fabrics, include polyesters, polyamides, polypropylenes and other synthetic materials. In some embodiments, the material of the outer layer 19 may comprise a stain-resistant material (which is has both water-repellant and oil-repellant properties), such as NANOTEX® fabric available from Nano-Tex of Oakland, Calif.

A variety of hydrophobic materials, including polyesters, polyamides, polypropylenes and a variety of other materials may also be used to treat fabrics, including fabrics formed from synthetic fibers and/or natural fibers. Stain-resistant treatments may also be used to treat the fabric(s) from which the outer layer 19 of a shield is formed. A non-limiting example of such a treatment is SCOTCH GUARD®, a perfluorobutaensulfonic acid (PFBS)-based product available from the 3M Company of St. Paul, Minn. Other non-limiting examples of such materials are disclosed by U.S. Pat. Nos. 6,472,476, 6,517,933, 6,544,594, and 6,855,772, the entire disclosures of each of which are, by this reference, hereby incorporated herein.

Alternatively, or in addition, the outer layer 19 of a shield 10 may comprise a material that reduces or eliminates soiling. Such materials may include, but are certainly not limited to, materials that include anti-microbia(agents (e.g., silver, silver-based antimicrobials, slime-based antimicrobials, 2-anthraquinone carboxylic acid, etc.).

The material of the outer layer 19 of a shield 10 may include a deodorant.

In some embodiments, the material(s) from which the outer layer 19 is formed may comprise a self-cleaning agent. In one example, a self-cleaning agent my comprise N—TiO₂ nanoparticles (i.e., particles that include a complex of titanium dioxide (TiNO₂) and nitrogen (N) ions), as disclosed by Wu, D., et al., “Realizing Visible-Light-Induced Self-Cleaning Property of Cotton through Coating N—TiO₂ Film and Loading AgI Particles,” Appl. Mat. & Interfaces 3(12): 4770-74 (2011), the entire disclosure of which is, by this reference, hereby incorporated herein. N—TiO₂ nanoparticles may be activiated by exposure to sunlight. In some embodiments, N—TiO₂nanoparticles may be used in conjunction with other materials to impart the material with additional self-cleaning properties. In a specific embodiment, silver iodide (AgI) nanoparticles may accelerate the ability of the N—TiO₂ nanoparticles to break down certain types of stains.

As another alternative, the outer layer 19 of a shield 10 may comprise a material from which contaminants, odors and other types of soiling may be readily removed. A cleanable outer layer 19 may comprise a material that may be cleaned (e.g., with water, with organic solvents or cleaning fluids, etc.) without requiring that the outer layer 19 be removed from the remainder of the shield 10 (i.e., from the encapsulant 13). Alternatively, or in addition, a cleanable outer layer 19 may be removable from and replaceable on the encapsulant 13.

In embodiments where the outer layer 19 may remain in place over the encapsulant 13 of a shield 10, the outer layer 19 may be formed from a material that does not absorb contaminants or that resists absorption of contaminants (e.g., a fabric with an internal waterproof coating, etc.). Such a material may enable the soiling to be removed from the outer layer 19 by wiping, use of pressurized fluid (e.g., compressed air, sprayed liquid, etc.), or otherwise.

Regardless of how the outer layer 19 of a shield 10 may minimize soiling, in some embodiments, the material(s) from which the outer layer 19 is formed may withstand sterilization while maintaining its ability to minimize soiling. Where an outer layer 19 of a shield may be sterilized, the shield 10 may be repeatedly used in sterile environments.

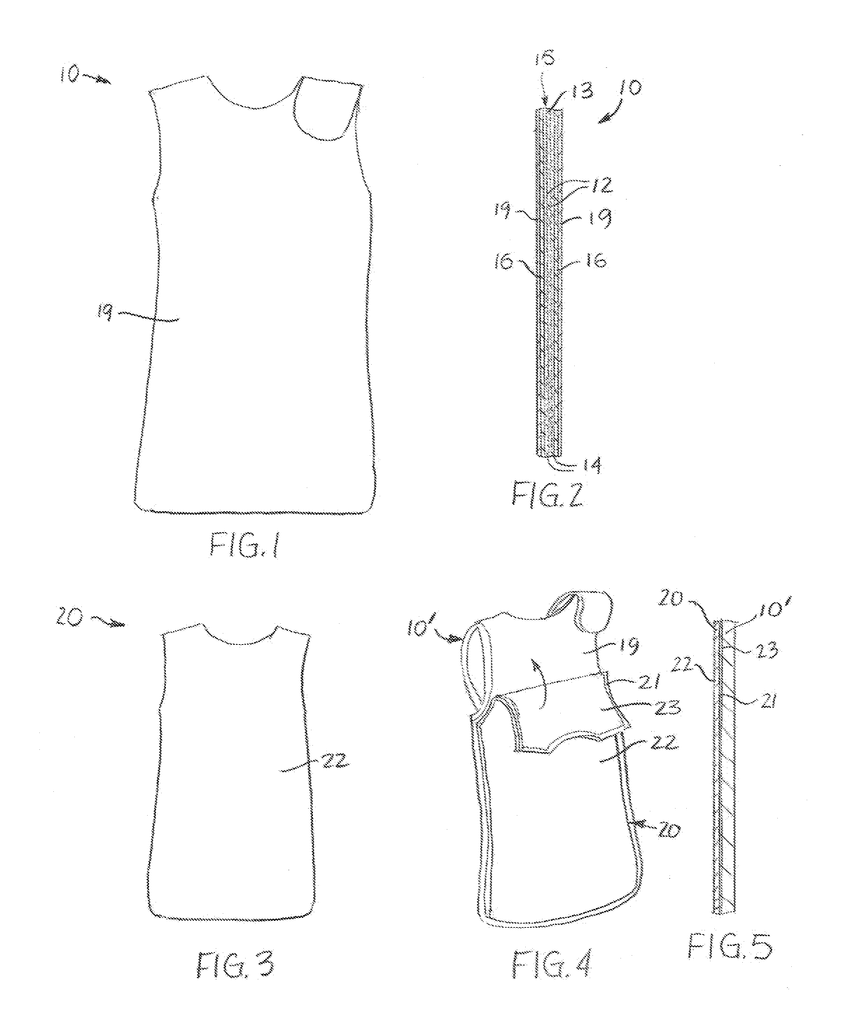

Turning now to FIGS. 3 through 5, an embodiment of a removable shell 20 for a conventional shield 10′ is depicted, and various embodiments of removable shells 20 are described. A removable shell 20 may comprise a fitted element configured to be placed over a particular, corresponding type of shield 10°. Stated another way, the removable shell 20 has a configuration that resembles that of a shield 10′ over which the removable shell 20 is configured or tailored to be placed. In the illustrated embodiment, the removable shell 20 comprises a fitted element configured to be positioned over an apron-type shield 10′.

In the embodiment depicted by FIGS. 3 through 5, the removable shell 20 includes an attachment surface 21 and an opposite, outer surface 22. The attachment surface 21 is configured to be placed against the shield 10′. The attachment surface 21 may, in various embodiments, carry an attachment element 23 that removably secures the removable shell 20 to the shield 10′. Without limitation, examples of the manner in which the attachment element 23 may function include adhesively (e.g., with a “low-tack,” reusable, pressure-sensitive adhesive material that leaves little or no residue when removed from a substrate (e.g., the adhesive used on POST-IT® brand products from the 3M Company, etc.), etc.), magnetically and mechanically (e.g., by way of complementarily configured snap-type elements, use of hook and loop type fasteners, etc.).

Although FIGS. 3 through 5 only show a shell 20 on one surface of a shield 10′, shells may be positioned over and, optionally, secured to more than one surface (e.g., both inside and outside surfaces, etc.) of a shield 10′ to minimize soiling of a plurality of surfaces.

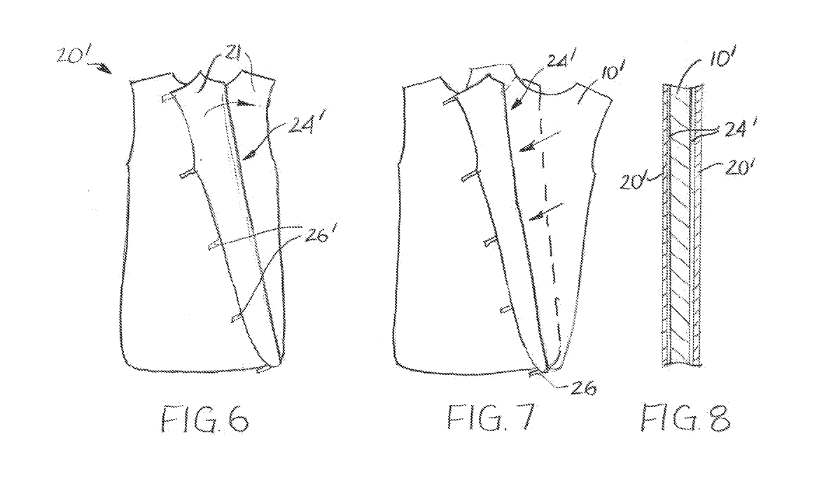

Alternatively, FIGS. 6 through 8 illustrate an embodiment of removable shell 20′ that defines an envelope for enclosing at least a portion of a shield 10′. Such an embodiment of a removable shell 20′ includes an opening 24′. The opening 24′ may receive the shield 10′ as the removable shell 20′ is placed over the shield 10′. The shield 10′ may be withdrawn from the opening 24′ as the removable shell 20′ is removed from the shield 10′. In some embodiments, one or more fasteners 26′ (e.g., snaps, buttons, hook and loop type fasteners, adhesive elements, etc., which may be secured directly to the shell 20′ or to straps or other elements secured to the shell 20′) may reversibly close the opening 24′.

In any embodiment, the removable shell 20, 20′ may be formed from a soil-minimizing material (e.g., a material that resists soiling, a material that reduces or eliminates soiling, a material from which soiling is readily removed, etc.), such as those disclosed above in reference to the outer layer 19 of a shield 10 that self-minimizes soiling.

Alternatively, any type of material (e.g., fabric, polymer film, paper or paper-like material, etc.) that provides a sufficient barrier to prevent soiling of an underlying shield 10′ and that may be removed, cleaned and replaced on the shield 10′ may be used to form the removable shell 20, 20′. Stain-resistant materials, such as fabrics formed from synthetic fibers (e.g., nylon, polyester, etc.), may be used to make a removable shell 20, for a shield 10′.

A removable shell 20, 20′ may include a radio-opaque material (e.g., it may include sublayer of radio-opaque material, as disclosed by the '611 Application, it may be impregnated with a non-toxic radio-opaque material, etc.). The inclusion of a radio-opaque material in the removable shell 20, 20′ may enhance the radio-opacity of selected portions of the shield 10′ or of the entire shield 10′.

In use, a removable shell 20, 20′ may be placed on and secured to a complementarily configured shield 10′ prior to use of the shield 10′. With the removable shell 20, 20′ in place, the shield 10′ may be used to limit the exposure of an individual (e.g., a healthcare professional, a patient, etc.) to ionizing radiation.

The removable shell 20, 20′ may remain in place on the shield 10′ during a single use, for a predetermined number of uses (e.g., five, ten, twenty, etc.), for a predetermined period of time (e.g., one day, one week, one month, etc.) or until it becomes noticeably (e.g., by sight, by smell, etc.) soiled. Thereafter, the removable shell 20, 20′ may be removed from the shield 10′. In some embodiments, once the removable shell 20, 20′ has been removed from the shield 10′, it may be disposed of. In other embodiments, a removable shell 20, 20′ that has been removed from a shield 10′ may be cleaned.

After removing a removable shell 20, 20′ from a shield 10′, but prior to using the shield 10′ to limit an individual's exposure to ionizing radiation, the shield 10′ may again be covered by a clean removable shell 20, 20′. That removable shell 20, 20′ may be a different cleaned shell, the same cleaned shell, or a new disposable or reusable shell.

Although the foregoing description contains many specifics, these should not be construed as limiting the scope of any of the appended claims, but merely as providing information pertinent to some specific embodiments that may fall within the scopes of the appended claims. Other embodiments may also be devised which lie within the scopes of the appended claims. Features from different embodiments may be employed in combination. The scope of the invention is, therefore, indicated and limited only by the appended claims and their legal equivalents. All additions, deletions and modifications to the disclosed embodiments that fall within the meaning and scopes of the appended claims are to be embraced thereby.

1. A shield for attenuating ionizing radiation, comprising:
a radio-opaque material;
an encapsulant for the radio-opaque material; and
a disposable outer layer configured to minimize soiling.

2. The shield of claim 1, wherein the outer layer comprises a protective material that is resistant to soiling.

3. The shield of claim 2, wherein the outer layer is formed from the protective material.

4. The shield of claim 2, wherein the protective material is applied to a material from which the outer layer is formed.

5. The shield of claim 1, wherein the outer layer comprises a material that eliminates soiling.

6. The shield of claim 1, wherein the outer layer comprises a material from which soiling is readily removable.

7. The shield of claim 1, wherein the encapsulant comprises or is blended with a material that minimizes soiling.

8. A shell for a shield that attenuates ionizing radiation, comprising:
a disposable covering configured to be positioned over and removed from a shield that attenuates ionizing radiation.

9. The shell of claim 8, wherein a material of covering is configured to prevent soiling of the covering.

10. The shell of claim 9, wherein the material of the covering is configured to minimize soiling of the covering.

11. The shell of claim 9, wherein the shell is configured to be cleaned and reused.

12. The shell of claim 9, wherein the shell is disposable.

13. The shell of claim 8, further comprising:
a fastener or adhesive for securing the covering to the shield.

14. The shell of claim 13, wherein the fastener is configured to secure the covering to a surface of the shield.

15. The shell of claim 13, wherein the fastener is configured to engage at least a portion of the shield.

16. A method for preventing soiling of a shield for attenuating ionizing radiation, comprising:
applying a shell to a shield for attenuating ionizing radiation;
positioning the shield over part of an individual;
activating a source of ionizing radiation, the shield preventing the individual from being exposed to at least some of the ionizing radiation;
removing the shield from the individual;
removing the shell from the shield; and
disposing of the shell.

17. The method of claim 16, further comprising:
applying a replacement shell to the shield.

18. The method of claim 16, further comprising:
cleaning the shell; and
re-applying the shell to a shield.

19. A shield for attenuating ionizing radiation, comprising:
a non-toxic radio-opaque material;
an encapsulant for the radio-opaque material; and
a material that minimizes soiling.

20. The shield of claim 19, wherein the encapsulant includes the material that minimizes soiling.

21. The shield of claim 19, wherein the material that minimizes soiling is blended with the encapsulant.

22. The shield of claim 19, wherein the material that minimizes soiling comprises a cover over the encapsulant.

23. The shield of claim 19, further comprising:
an outer layer over the encapsulant.

24. The shield of claim 23, wherein the outer layer comprises the material that minimizes soiling.
